(19) United States
(12) Patent Application Publication
(10) Pub. No.: US 2010/0307613 A1
(43) Pub. Date: Dec. 9, 2010

(54) DEVICE FOR BLOCKING AND RELEASING A FLUID FLOW AND ASSOCIATED METHOD

(75) Inventors: Guido Temme, Bad Iburg (DE); August Wallmeyer, Recke (DE)

Correspondence Address: Rankin, Hill & Clark LLP, 23755 Lorain Road, Suite 200, North Olmsted, OH, 44070, US

(73) Assignee: ELSTER GMBH, Lotte (Buren) (DE)

(21) Appl. No.: 12/746,886

(22) PCT Filed: Nov. 17, 2008
(86) PCT No.: PCT/EP2008/065701

§ 371 Date: Aug. 25, 2010

(30) Foreign Application Priority Data
Dec. 11, 2007 (EP) 07122909.0

(51) Int. Cl. F16K 39/02; F16K 43/00

(52) U.S. Cl. 137/517; 137/551

(57) ABSTRACT

The invention relates to a device for blocking and releasing a fluid flow having a fluid inlet and a fluid outlet. A main opening is disposed between the inlet and the outlet and associated with a main blocking element that can seal off the main opening. An actuation device can move the main blocking element from the open position to the closed position, and the main blocking element is disposed in the closed position such that an increased fluid pressure at the fluid inlet relative to the fluid outlet brings about a press force holding the main blocking element in the closed position. A fluid overflow path is provided between the fluid inlet and the fluid outlet that can be sealed off by the actuation device. The main blocking element can be released by the actuation device and the fluid overflow path can be opened by the actuation device. In the release position, an opening force for moving the main blocking element into the open position can be applied thereto, so that it remains in the closed position only as long the fluid pressure overcompensates for the opening force.

The invention relates to a device for blocking and releasing a fluid flow and an associated method.

The device relates, in particular, to a blocking and release device for a fluid flow, wherein the device has a fluid inlet and a fluid outlet and wherein a main opening is arranged in the fluid path between the inlet and outlet. That the main opening has an associated main blocking means, which can adopt at least a closed position and an open position with respect to the main opening so that the main blocking means is moveable with the aid of an actuating device out of the open position into the closed position and can be held in the closed position.

Devices of the aforementioned type are regularly used in valve assemblies for gas supply or generally in the supply of fluid so that such devices are used, for instance, in gas meters or gas controllers.

It is often necessary selectively to release or to interrupt a fluid flow between the fluid inlet and fluid outlet of such a device. Gas meters, for instance, are known from the prior art which release or interrupt a gas supply to a customer network (e.g. in an apartment or house), depending on whether the customer has made payment for the gas supply. Such a check on the payment can be implemented, for instance, by means of so called Prepaid methods or by means of a remote control system by the gas supplier whereby, if necessary, remote communication is established between the blocking and releasing device and the supplier.

In the event that the gas supply to a connection is to be blocked, an appropriate valve is closed and the fluid flow is interrupted. This processes is, however, associated with the problem that when the gas connection is again switched on, gas flows again into the pipe network of the customer and into corresponding consuming devices which are connected to the pipe network. If a consuming device is active at the time of release and gas can thus flow into the consuming device, an outflow of gas and a considerable risk as a result of unconsumed gas can occur. Such an event can occur, in particular, if a consuming device was active at the time of blocking of the gas supply or is activated during the time of the blockage.

So called gas shortage safety devices are known in the prior art, which can be incorporated for this purpose into the fluid path upstream of appropriate devices and block the fluid path in the event that a gas shortage occurs on the supply side. They only conduct gas again if a pressure balance has occurred on the two sides of the gas shortage safety device and thus balanced pressure conditions prevail in the supplier network and consumer network.

Furthermore, different types of safety device using sensors and electronic analysers are known which permit monitoring of the flow or pressure and block a corresponding connection, if required.

It is, however, desirable for safety reasons to construct such a safety device such that erroneous release of the gas as a result of incorrect processing or false sensor signals or analysis cannot occur.

The invention has the object of providing an improved device for blocking and again releasing a fluid flow which is reliable in use and is simple and favourable to manufacture.

The solution in accordance with the invention is provided by a device with the features of claims 1 to 13 and a method with the features of claims 14.

In accordance with the invention, the main blocking means in the device in accordance with the preamble is so arranged in the closed position that a pressure drop from the fluid inlet with respect to a fluid outlet causes a pressure which urges the main blocking means into the closed position or holds them in it so that the main blocking means is thus retained in its closed position by the corresponding pressure drop. In addition to this force, however, an additional retaining force can be exerted in the closed position by the actuating device.

A fluid overflow path is also provided in the device, which constitutes a blockable and releasable fluid passage between the fluid inlet and fluid outlet and which may be opened and closed by the actuating device.

The main blocking means is movable by the actuating device out of the open position into the closed position. The main blocking means is releasable from the closed position by the actuating device. Released means in this context that movement out of the closed position is made possible (released) for the main blocking means but it is not actively moved out of it. The main blocking means is accordingly not necessarily moved when released but merely made free to move, that is to say unlocked. Whilst the movement into the closed position occurs with a mechanical force, it is possible that, when released, the main blocking means moves directly into the open position but it can also remain in the closed position. The latter will particularly be the case if the differential pressure which still exists, which acts on the main blocking means in the closed position, holds it in the closed positions. The main blocking means can be of a bistable design such that it adopts its stable states in the open and closed positions. Release means only that no further retaining force is exerted on the main blocking means by the actuating device.

The actuating device can also open the fluid overflow path. This opening of the fluid overflow path can occur some simultaneously with the release of the main blocking means but the release can also occur before or after the opening of the fluid overflow path. This opening of the overflow path occurs actively, that is to say the opening process is effected unconditionally, in contrast to the release described above.

The device is constructed so that an opening force to move the main blocking means into the open position may be exerted on the main blocking means in the released position. This opening force can be exerted continuously on the main blocking element in the released position, e.g. by mechanical biasing or the action of a magnetic force. The force can, however, also be exerted discontinuously, e.g. by temporarily switching on a drive in order to exert a limited test force in the direction of opening. The main blocking means is accordingly not held by the actuating device in the closed position when in the released position but has, potentially not yet moved out of it. In this state, the aforementioned pressure differential acts continuously on the main blocking means and urges it into the closed position. The opening force, or test force, which urges it out of the closed position into the open position, acts in the opposite direction, at least at certain times. The main blocking means accordingly remains in the closed position only as long as the fluid pressure, which prevails at the fluid inlet, is elevated with respect to the fluid outlet and the resulting pressure overcompensates for the opening force.

An opening force can be produced with any desired force-exerting means, e.g. springs, flexible materials, magnetic forces, motor couplings or the like.

If the device is to be blocked, the main blocking means is moved into the closed position and the overflow opening is closed by the actuating device. Accordingly, no fluid flow occurs between the gas inlet and gas outlet. If, however, on the other hand, the fluid flow is to be released again, only the overflow path is opened but the main blocking means is released. Depending on the pressure differential, it remains in its closed position. The overflow path is so dimensioned that, with a predetermined gas pressure at the gas inlet (e.g. from the supply network), an insignificant flow volume of the fluid through the overflow opening or the overflow path is not exceeded. Accordingly, a volume of fluid or volume of gas representing a danger does not flow through the overflow path to the fluid outlet and into the gas network of a consuming device. If all the consuming devices in the gas network on the outlet side are shut off, a pressure corresponding to the gas inlet pressure builds up on the gas outlet side via the overflow path. This results in the force exerted on the main blocking means by the pressure differential decreasing and finally disappearing so that the main blocking means is urged by the biasing force into the open position. In this open position, a normal open position of a conventional valve is again finally achieved.

In its function, the device in accordance with the invention accordingly fulfils not only the function of a conventional blocking valve but also of an extremely robust and reliable safety device. A substantial advantage of this device is to be seen in its autonomous operation, which can enable use of the device and activation of the gas supply without intervention by the user. A user guide e.g. by means of a display mounted on the device or in conversation with the technical support of the supplier, is also unnecessary.

By comparison with a conventional valve, the device in accordance with the invention has an additional state, namely the release of the valve from the blocked position or closed position. In the closed position, all the fluid connections between the inlet and outlet are interrupted and in the open position all the fluid paths are open. In the released position, on the other hand, only an overflow path of bypass is released with a reduced flow and the main opening is blocked with the main blocking means. A fluid flow therefore only occurs which as regards its risk is insignificant but which results in a pressure balance and finally in complete opening of the device.

As a result of the construction of the system, it can be used extremely reliably and without intervention for maintenance or intervention for operation. Such a device can, for instance, be released for gas supply by a signal from a remote position (e.g. after a payment has been made by the consumer) without there being a risk of permitting gas to flow out though consuming devices which have not been shut off. Only when the customer has switched off all gas consuming devices and a gas pressure can thus be built up in the customer network is the valve completely open.

The actuating device of the device in accordance with the invention can be of any desired construction and it can be constructed e.g. in the form of simple button mechanism to be operated by a user or in the form of a motor-driven device, which can also be remote incontrollable.

What fluid flow the fluid overflow path allows to pass through, when it is opened, is dependent on one hand on the pressure differential and on the other hand on the flow path (length and cross sectional area). Upper limits of a flow volume which passes through, which do not result in an ignitable mixture in the installation region of a customer, are generally to be maintained by gas suppliers so that such upper limits are generally known to the expert in gas or fluid supply.

In one embodiment of the invention, the main blocking means is constructed with a valve plate, which is sealingly engagable with the margins of the main opening.

Any desired sealing possibilities for the construction of the main locking means are basically possible but a valve plate is particularly preferred due to the flat engagement and proven functionality. The squeezing forces and clogging with such a valve plate are generally more favourable by comparison with other seals (e.g. plug seals). Thus even after relatively long periods of closure, when the apparatus in accordance with the invention is to be released it can be reliably released again and the device opened.

In a further embodiment of the invention, the overflow path is constructed in the form of a flow opening in the main blocking means.

If the overflow path is constructed in the main blocking means itself, the actuating device can be coupled not only to the main blocking means but also to the overflow path in a particularly simple manner. The overflow path can be constructed, for instance, in the form of a flow opening in the main blocking means, which is closable and openable by the actuating device. The actuating device can, for instance, urge the main locking means into the closed position and simultaneously close the flow opening in the engagement region between the actuating device and the main blocking means. Other constructions are also possible, e.g. a deliberately different sealing of the main blocking means depending on the pressure exerted on it. It should merely be ensured at all times that the fluid flows through the main opening and the overflow path are blocked on closing and that the in the released position merely a reduced fluid flow less than a critical flow passes through the overflow path,

The device preferably has an actuating device with a movable retaining section, on which the main blocking means is movably retained between two stops. A first of the stops is so arranged that it engages the main blocking means when the actuating device and the main blocking means are moved into the closed position.

The first stop accordingly retains the main blocking means in the closed position. Between the two stops, the main blocking means is, however, movable on the actuating device between the stops, whereby the release of the main blocking means may be achieved so that as a result of the movability of the main blocking means on the actuating device, it can be achieved that the retaining force of the actuating device on the main blocking means is removed on release but the main blocking means nevertheless remains in its sealed position.

The first stop is preferably spaced in the released position from the main blocking means and defines an end position for the main blocking means in the open position.

On release, the first stop moves out of engagement with the main blocking means and moves into the open position. The main blocking means remains, however, in the closed position so long as the pressure differential holds it there. When movement occurs, the main blocking means and the actuating device move towards one another.

In a further embodiment of the invention, a spring element is arranged between the stops and the main blocking means, by which the main blocking means is biased into the released position.

When release occurs, the main blocking means accordingly remains in the locked position against the biasing force since this biasing force is over compensated for by the pressure differential. The biasing can effected with respect to any desired one of the stops, e.g, as a tensional spring force with respect to the first stop or as a compressive spring force with respect to the second stop. With such a construction, the biasing force is applied only when the main blocking means is released. It is, however, also possible to apply the biasing force at the same time as the main blocking means moves into the closed position.

In an alternative construction of the invention, the main blocking means is so arranged in the fluid path that it is closable against the pressure of the fluid. In contrast to the construction described above, a pressure acts, when fluid pressure has built up on the inlet side, in the direction of the open position of the main blocking means.

This alternative construction of the device for blocking and releasing a fluid flow also has a fluid inlet and a fluid outlet and a main opening arranged in the fluid path between the fluid inlet and fluid outlet. Associated with the main opening is a main blocking means, which can adopt at least a closed position and an open position with respect to the main opening. An actuating device moves the main blocking means out of the open position into the closed position.

The main blocking means is, however, so arranged in the closed position that a fluid pressure at the fluid inlet, which is elevated with respect to the fluid outlet, causes a force urging the main blocking means into the open position. Closing of the main blocking means is therefore effected against the pressure of the fluid.

Locking means are also provided in the device for locking the main blocking means in the closed position. These locking means can be constructed in the form of e.g. releasable locking means or other mechanical barriers. The locking means have a pressure differential barrier, which can adopt different switching or actuation states in dependence on a pressure differential acting on it. For instance, a bistable membrane (a type of clicking frog) can be used which can actuate a switch or mechanism depending on the differential pressure acting on both sides. The locking means with the differential pressure barrier are so constructed that they lock the main blocking means when a predetermined minimum differential pressure between the fluid inlet and fluid outlet acts on the differential pressure barrier.

A fluid overflow path is provided between the fluid inlet and fluid outlet, which is closable by the actuating device when the main blocking means moves into the closed position. The main blocking means is releasable from the closed position by the actuating device and the fluid overflow path is to be opened by the actuating device so that the main blocking means is now held in the released position only by the locking means.

However, the locking means hold the main blocking means in this position only if the pressure differential is greater than a predetermined minimum differential. If the fluid pressure on the outlet side rises as a result of the fluid flow through the overflow path (because all consuming units on the outlet side are closed), the pressure differential will fall below this minimum value after a certain period of time and the locking means will release the main blocking means. The main blocking means then move into the open position. If the pressure differential remains above the predetermined minimum pressure differential, the main blocking device remains locked and in a closed position.

Further preferred embodiments of the invention are given in the dependent claims, the advantages of which will also be clear from the following description of the preferred embodiments.

The invention will now be described in more detail with reference to the accompanying drawings.

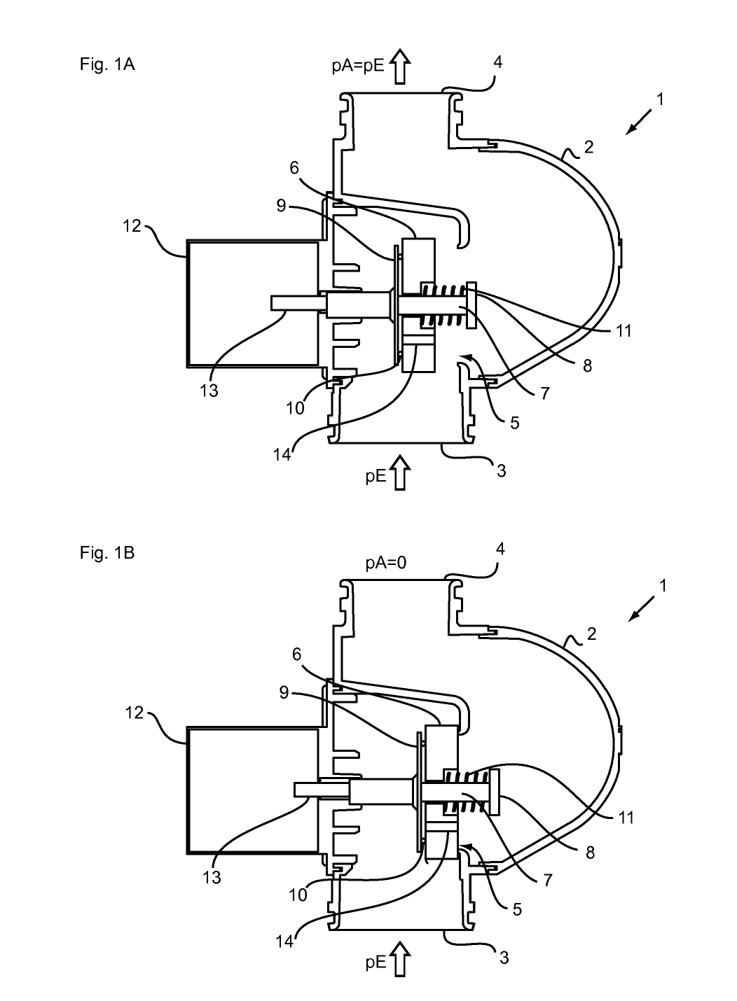

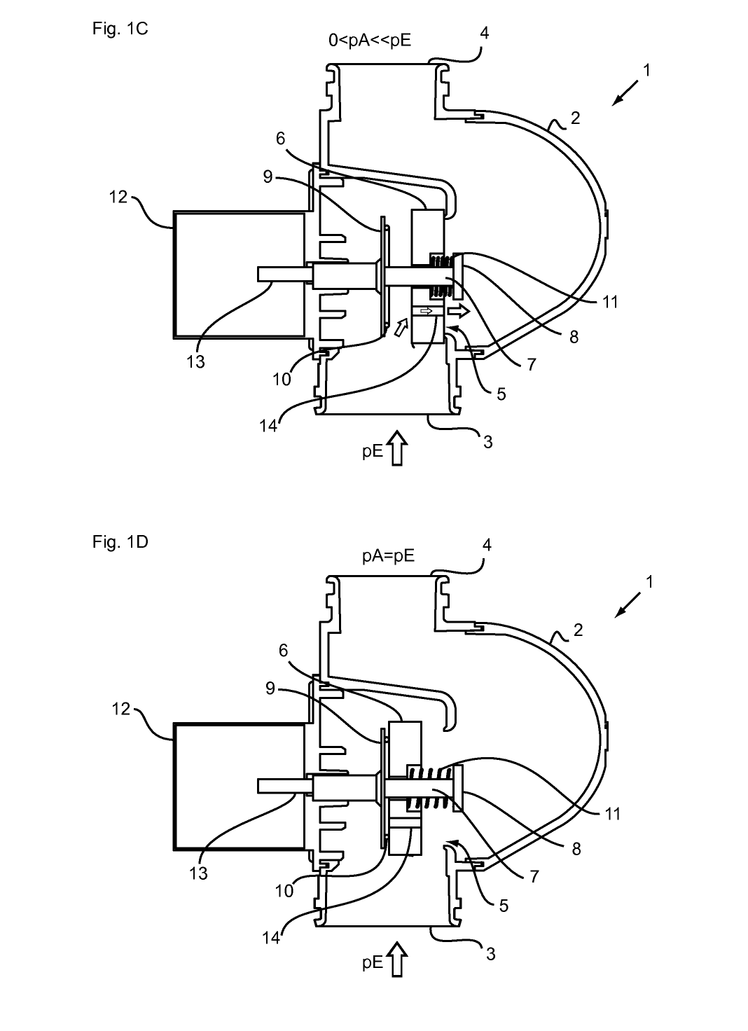

FIG. 1a shows a device in accordance with the invention for blocking and releasing a fluid flow in accordance with a first exemplary embodiment, wherein the device is situated in the open position.

FIG. 1b shows the device in accordance with the first exemplary embodiment, wherein the device is in closed position.

FIG. 1c shows the device in accordance with the first exemplary embodiment, wherein the device is in the released position.

FIG. 1d shows the device in accordance with the first exemplary embodiment, wherein the device is again in the open position.

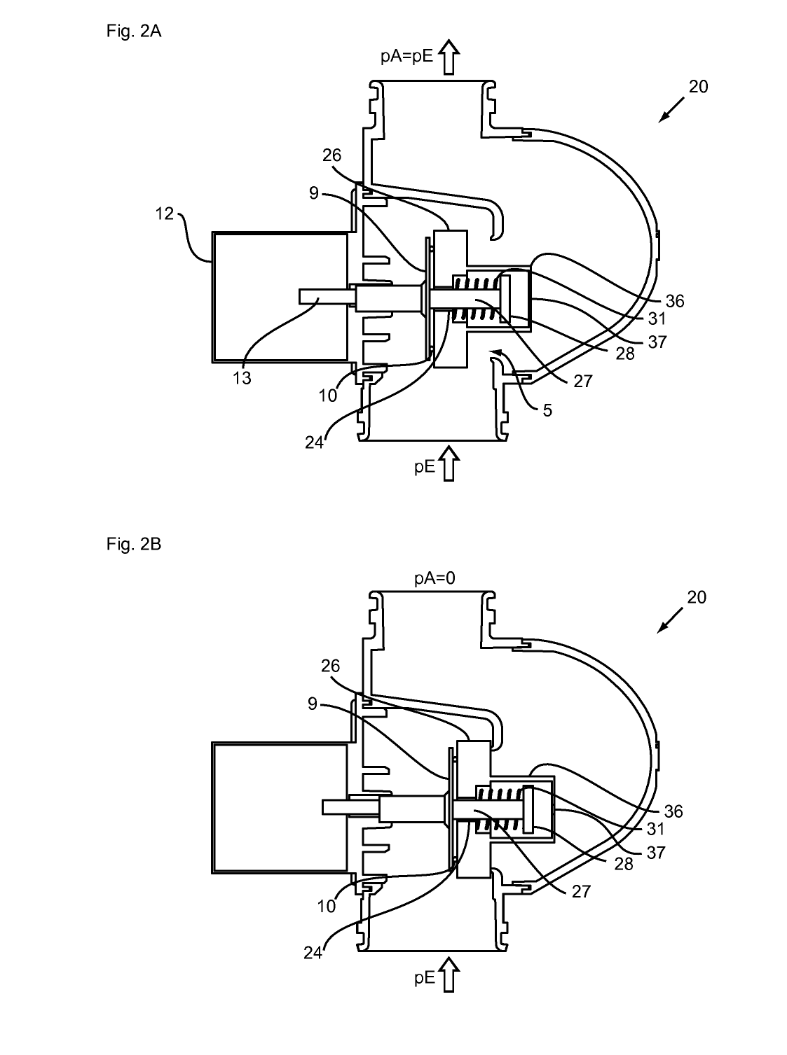

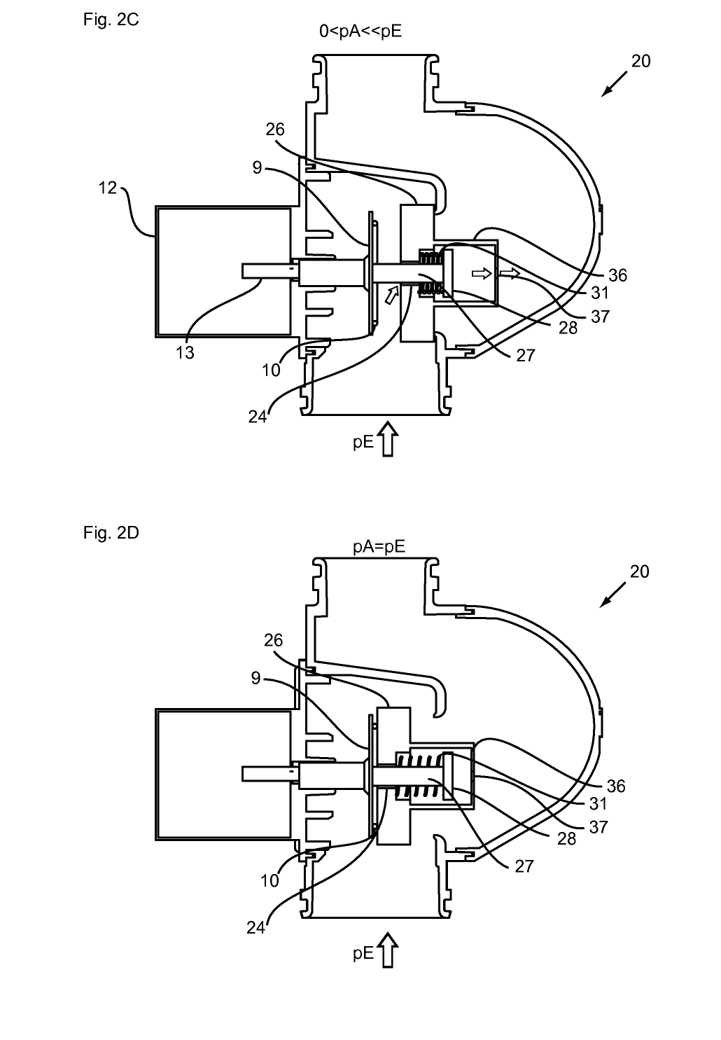

FIG. 2a shows the device in accordance with a second exemplary embodiment, wherein the device is in the open position.

FIG. 2b shows the device in accordance with the second exemplary embodiment, wherein the device is in the closed position.

FIG. 2c shows the device in accordance with the second exemplary embodiment, wherein the device is in the released position.

FIG. 2d shows the device in accordance with the second exemplary embodiment, wherein the device is again in the open position.

The device 1 in FIG. 1a has a housing 2, on which a gas inlet 3 and a gas outlet 4 are formed. Formed between the gas inlet 3 and gas outlet 4 is a main opening 5, which provides a fluid path for a fluid flowing though the device 1. Associated with the opening 5 is a main blocking means 6 constricted in the form of a sealing plate, which is arranged upstream, seen from the main opening 5, that is to say in the direction of the gas inlet 3. Formed in the main blocking means 6 is an overflow path or bypass in the form of a flow passage 14, The function of the overflow path 14 will be described in more detail below.

The sealing plate 6 is guided on a shaft-like section 7 of an actuating device. Constructed on both sides of the section 7 are stops or abutments 8 and 9. The stop 9 is constructed in the form of a plate, which is engagable with the main blocking means 6 via an annular seal 10. The main blocking means is also biased by means of a spring 11 against the stop 8.

The actuating device also has a drive 12, which is coupled to a shaft section 13, by means of which the section 7 and the two stops 8 and 9 are axially displaceable or movable so that the main blocking means 6 is movable to a closed position with respect to the main opening 5 under the action of the stop plate 9.

The entire actuating device includes the element 7, 8, 9, 10, 11, 12 and 13 in the illustrated example.

FIG. 1a shows the device in accordance with the invention in an open position, i.e. a gas pressure pE applied on the input side (with the output side open) results in a fluid flow through the device and 1 and the gas pressure pA on the output side corresponds to the input pressure pE (ignoring pressure losses in the open device). If the output side is blocked (e.g. all the consuming devices are switched off), a uniform static pressure builds up in the device.

Starting from this open position shown in FIG. 1A, the device can be closed to block the gas flow. For this purpose, the actuating device moves the stops 8 and 9 with the section 7 between them axially in the direction of the main opening 5 by means of the drive 12 and via the shaft 13 so that the valve plate 6, which is pushed by the plate-like stop 9, is engaged with the marginal edges of the main opening 5. The closed position thus reached is shown in FIG. 1b.

As mentioned above, a flow passage (flow opening) 14 is formed in the main blocking means 6. It is so positioned that it lies within the sealing region of the annular seal 10 so that when the stop 9 and the sealing means 10 are pressed against the main blocking means 6, the flow passage 14 is sealed with respect to the fluid pressure pE.

The main blocking means 6 also sealingly engages the main opening 5 in the blocked position. Both the flow paths for the fluid (main opening 5 and flow passage 14) are thus blocked. The inlet pressure pE acts on the main sealing element 6 in this closed position and thus exerts a closing force on the sealing element 6, provided that the input pressure pE is greater than the output pressure pA. The lower is the outlet pressure pA, the greater is the pressure differential pE-pA. If consuming devices on the outlet side of the device were active at the time of blocking of the device, the outlet pressure 6 decreases as a result of the open consuming devices to atmospheric pressure so that the pressure differential pE-pAtmosphere exerts a force on the main sealing means.

It is now to be possible to release the blocking of the gas flow again from this blocked position, but only in the event that no unintentional outflow of gas results from it. One can only assume safe conditions for the opening process if all the gas consuming devices on the output side are blocked and the network on the output side is thus closed or sealed.

If the device is actuated in this blocked position in order to reopen the device, this results initially in the release of the device shown in FIG. 1c. Such an opening command can be effected, for instance, by remote control of the drive 12. FIG. 1c shows the case in which the gas pressure on the outlet side has completely dissipated, e.g. as a result of an active gas consuming device at the time of blocking of the device.

As shown in FIG. 1c, the drive 12 actuates the shaft 13 and pulls the stop 9 with the sealing rings 10 back in the axial direction so that the inlet pressure, which is greater than the outlet pressure, however, still acts on the sealing plate 6 and forces it against the main opening 5. As a result of the movement back of the actuating device, the spring 11 between the sealing means 6 and stop 8 is compressed and now exerts a spring force on the sealing means 6, which biases it in the direction of the open position. This spring force is, however, too small to move the blocking means 6 against the force, which is caused by the pressure differential pE-pA, into the open position.

In this released position shown in FIG. 1c, the plate-shaped stop 9 with the sealing means 10 is, however, no longer situated in engagement with the sealing ring 6 so that the overflow opening 14 is exposed. The overflow opening 14 (shown on an enlarged scale in the drawings for reason of clarity) now provides an overflow path for the gas under pressure on the inlet side. The overflow opening is, however, so dimensioned that, even in the event that one or more consuming devices on the output side are open and accordingly gas has which has passed through flows out of them, there is no danger from the outflowing gas since the volume of the flow through the overflow opening is very limited. If, however, the consuming devices on the output side are closed or if they are closed in this state of the device, a pressure gradually builds up on the output side which corresponds to the input pressure. As soon as the outlet pressure is approximately the same as the inlet pressure (e.g. because the gas network of the user has no leaks or open consuming devices), the pressure on the sealing means 6 decreases (the differential pressure pA-pE decreases) and the spring force of the spring 11 moves the sealing means out of the closed released position back into the open position.

This state is reached in FIG. 1d and the gas valve is again completely open and ready to initiate a new blocking process.

This device is completely independent of the reading of sensor values or of electronic processing devices which are susceptible to failure. The release of the gas blocking device is effected entirely mechanically and on the basis of physical principles and furthermore, in the event that there is no pressure shortage on the output side, the device behaves like a normal valve, i.e. complete opening occurs immediately with release since no pressure balance is necessary for opening.

A modified embodiment of the invention is shown in FIGS. 2a to 2b. In this device 20, the flow opening 24 in the blocking means 26 is formed around the shaft 27. The sealing plate 26 thus has in this region either a certain clearance with respect to the shaft 27 or the central region is made of a gas-permeable material. Also formed on the main blocking means 26 is a projection 36 with a cavity, which has a wall 37.

This embodiment ensures a better seal of a main opening and requires smaller manufacturing tolerances. The shaft 27 with the projection 28 and the helical spring 21 are encapsulated within the housing projection 36.

FIG. 2b shows the closed position of the second embodiment, wherein the flow opening 24 is again sealed by the plate-shaped stop 9 and the sealing elements 10.

FIG. 2c shows the released position, in which the plate-shaped projection 29 is lifted away and the flow opening 24 along the shaft 27 and through the bore 37 opens the fluid path.

If the pressure outlet side in the consumer network is blocked, a pressure balance can occur and the device moves as a result of the biasing of the spring back into the open position, which is shown in FIG. 2d.

The advantage of this construction is that the sealing means 26 need not be matched precisely to the shaft 27. A sufficient clearance can instead be left around the shaft. The limitation of the fluid flow is effected by the bore or nozzle 37, whereby this opening maybe precisely formed in a structurally simple manner.

Numerous modifications are possible in the context of the invention. For instance, the overflow opening or the bypass can be formed separately and spaced from the main blocking means. It can also be formed in a wall surface and be opened and closed by the actuating device. Depending on the field of application, it is also clear that the overflow opening can be differently constructed in order to take account of the different pressure values on the inlet side so that only an insignificant flow volume passes through the overflow opening at all times and flows into the pipe network of a consumer.

1-15. (canceled)

16. A device for blocking and releasing a fluid flow including a fluid inlet and a fluid outlet, a main opening arranged in the fluid path between the fluid inlet and the fluid outlet, a main blocking means which is associated with the main opening and can adopt at least a closed position and an open position with respect to the main opening, an actuating device, which can move the main blocking means out of the open position into the closed position, wherein the main blocking means is so arranged in the closed position that a fluid pressure at the fluid inlet, which is elevated with respect to the fluid outlet, results in a pressure which retains the main blocking means in the closed position, that a fluid overflow path is provided between the fluid inlet and the fluid outlet, which is closable by the actuating device, wherein the device is so constructed such that the main blocking means is releasable from the closed position by the actuating device, and wherein the actuating device does not exert a retaining pressure on the main blocking means and the fluid overflow path is openable by the actuating device, that, in the released position, an opening force is exerted on the main blocking means by a biasing of the main blocking means in the direction of the open position so that it only remains in the closed position if the fluid pressure overcompensates for the biasing force.

17. A device as claimed in claim 16, wherein the blocking means has a valve plate, which is sealingly engagable with the margins of the main opening.

18. A device as claimed in claim 16, wherein the overflow path is constructed as a flow opening in the main blocking means.

19. A device as claimed in claim 16, wherein the actuating device has a movable retaining section, on which the main blocking means is movably held between two stops, and wherein a first of the stops is so arranged that it engages the main blocking means on movement into the closed position.

20. A device as claimed in claim 19, wherein the first stop is spaced from the main blocking means in the released position and defines an end position for the main blocking means in the open position.

21. A device as claimed in claim 19, wherein a spring element is arranged between one of the stops and the main blocking means, by which the main blocking means is brazed into the released position.

22. A device as claimed in claim 19, wherein the retaining section between the stops is of a rod shape and passes through the main blocking means so that the main blocking means is slidingly retained on the retaining section between the stops.

23. A device as claimed in claim 22, wherein the overflow path is formed between the main blocking means and the retaining section.

24. A device as claimed in claim 19, wherein the first stop has a plate-shaped engagement surface, which is sealingly engagable with the main blocking means so that when it engages the main blocking means the overflow path is closed.

25. A device as claimed in claim 16, wherein the overflow path is so constructed that with a predetermined maximum pressure drop between the inlet and outlet, the fluid flowing though does not exceed a predetermined fluid flow volume.

26. A gas meter with a device for blocking and releasing a fluid flow including a fluid inlet and a fluid outlet, a main opening arranged in the fluid path between the fluid inlet and the fluid outlet, a main blocking means which is associated with the main opening and can adopt at least a closed position and an open position with respect to the main opening, an actuating device, which can move the main blocking means out of the open position into the closed position, wherein the main blocking means is so arranged in the closed position that a fluid pressure at the fluid inlet, which is elevated with respect to the fluid outlet, results in a pressure which retains the main blocking means in the closed position, that a fluid overflow path is provided between the fluid inlet and the fluid outlet, which is closable by the actuating device, wherein the device is so constructed such that the main blocking means is releasable from the closed position by the actuating device, and wherein the actuating device does not exert a retaining pressure on the main blocking means and the fluid overflow path is openable by the actuating device, that, in the released position, an opening force is exerted on the main blocking means by a biasing of the main blocking means in the direction of the open position so that it only remains in the closed position if the fluid pressure overcompensates for the biasing force.

27. A device as claimed in claim 17, wherein the overflow path is constructed as a flow opening in the main blocking means.

28. A device as claimed in claim 17, wherein the actuating device has a movable retaining section, on which the main blocking means is movably held between two stops, and wherein a first of the stops is so arranged that it engages the main blocking means on movement into the closed position.

29. A device as claimed in claim 18, wherein the actuating device has a movable retaining section, on which the main blocking means is movably held between two stops, and wherein a first of the stops is so arranged that it engages the main blocking means on movement into the closed position.

30. A device as claimed in claim 20, wherein a spring element is arranged between one of the stops and the main blocking means, by which the main blocking means is brazed into the released position.

31. A device as claimed in claim 20, wherein the retaining section between the stops is of a rod shape and passes through the main blocking means so that the main blocking means is slidingly retained on the retaining section between the stops.

32. A device as claimed in claim 21, wherein the retaining section between the stops is of a rod shape and passes through the main blocking means so that the main blocking means is slidingly retained on the retaining section between the stops.

33. A device as claimed in claim 20, wherein the first stop has a plate-shaped engagement surface, which is sealingly engagable with the main blocking means so that when it engages the main blocking means the overflow path is closed.

34. A device as claimed in claim 21, wherein the first stop has a plate-shaped engagement surface, which is sealingly engagable with the main blocking means so that when it engages the main blocking means the overflow path is closed.

35. A device as claimed in claim 22, wherein the first stop has a plate-shaped engagement surface, which is sealingly engagable with the main blocking means so that when it engages the main blocking means the overflow path is closed.

36. A device as claimed in claim 23, wherein the first stop has a plate-shaped engagement surface, which is sealingly engagable with the main blocking means so that when it engages the main blocking means the overflow path is closed.
